(19) United States
(12) Patent Application Publication
(10) Pub. No.: US 2017/0171295 A1
(43) Pub. Date: Jun. 15, 2017

(54) FILE UPLOAD AND DOWNLOAD METHODS AND ASSOCIATED SERVER

(71) Applicant: Synology Incorporated, Taipei (TW)

(72) Inventors: Ying-Chang Sung, Taipei City (TW); Che-Wei Pai, Keelung City (TW)

(21) Appl. No.: 15/186,559

(22) Filed: Jun. 20, 2016

(30) Foreign Application Priority Data
Dec. 9, 2015 (TW) 104141257

(51) Int. Cl. H04L 29/08; G06F 17/30; H04L 29/06

(52) U.S. Cl. CPC H04L 67/06; H04L 67/42; H04L 67/22; G06F 17/30233

(57) ABSTRACT

A server includes a processor and a storage unit, the processor arranged to control operations of the server. The storage unit is arranged to store a program code, which is read by an electronic device via a network and executed by a browser of the electronic device. When the program code is executed by the browser, the browser performs the following steps: receiving an upload command, and copying a file corresponding to the upload command to a virtual file system provided by the browser; partitioning a file into a plurality of portions; sequentially uploading the portions to the server via the network, and recording an upload progress of the file; and when the upload is interrupted and the electronic device re-uploads the file, the browser directly uploads the remaining portions of the file that have not yet been transmitted to the server according to the recorded upload progress.

### BACKGROUND OF THE INVENTION

1. Field of the Invention

The present invention relates to file upload and download methods, and more particularly, to a transmission resuming method.

2. Description of the Related Art

When a user utilizes a browser to upload a file to a remote server or download a file from the server, if uploading/downloading of the file is interrupted (e.g. the network is disconnected) or the browser is accidentally shut down, the file is required to be re-uploaded/downloaded. In order to complete these tasks, the user must open a folder to find the file to be uploaded or access a location for storing the file to be downloaded. This may cause inconvenience to the user and consume unnecessary network bandwidth.

### SUMMARY OF THE INVENTION

An objective of the present invention is therefore to provide a file upload and download method, and an associated server, which can directly resume file uploading/downloading from the point at which it breaks down. The problem of unnecessary re-uploading/downloading of the entire file as encountered in the related art can thereby be solved.

An embodiment of the present invention provides a server. The server includes a processor and a storage unit. The processor is arranged to control operations of the server. The storage unit is arranged to store at least one program code, in which the program code is arranged to be read by an electronic device via a network and is executed by a browser of the electronic device. When the program code is executed by the browser, the browser performs the following steps: receiving an upload command, and copying a file corresponding to the upload command to a virtual file system provided by the browser; partitioning a file in the virtual file system into a plurality of portions; sequentially uploading the portions to the server via the network, and real-time recording an upload progress of the file; and when uploading of the file is interrupted and the file is required to be re-uploaded, transmitting remaining portions of the file that are not yet transmitted to the server according to a recorded upload progress.

Another embodiment of the present invention provides a file upload method applicable to a browser. The file upload method includes: receiving an upload command, and copying a file corresponding to the upload command to a virtual file system provided by the browser; partitioning the file in the virtual file system into a plurality of portions; sequentially uploading the portions to the server via a network, and real-time recording an upload progress of the file; and when uploading of the file is interrupted and the file is required to be re-uploaded, transmitting remaining portions of the file that are not yet transmitted to the server according to a recorded upload progress.

Yet another embodiment of the present invention provides a server. The server includes a processor and a storage unit. The processor is arranged to control operations of the server. The storage unit is arranged to store at least one program code. The program code is arranged to be read by an electronic device via a network, and is executed by a browser of the electronic device. When the browser executes the program code, the browser executes the following steps: receiving a download command, and sequentially downloading a plurality of portions of a file corresponding to the download command from the server to a virtual file system provided by the browser via the network, and real-time recording a download progress of the file; and when downloading of the file is interrupted and the file is required to be re-downloaded, downloading remaining portions of the file that are not yet downloaded to the virtual file system according to a recorded download progress.

Still another embodiment of the present invention provides a file download method applicable to a browser. The file download method includes: receiving a download command, and sequentially downloading a plurality of portions of a file corresponding to the download command to a virtual file system provided by the browser via a network, and real-time recording an download progress of the file; when downloading of the file is interrupted and the file is required to be re-downloaded, downloading remaining portions of the file that are not yet downloaded to the virtual file system according to a recorded download progress; and when all portions of the file are downloaded to the virtual file system, copying the file to a file system of the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a system according to an embodiment of the present invention.

FIG. 2 is a flowchart illustrating a method of an electronic device uploading a file to a server.

FIG. 3 is a diagram illustrating a scenario in which a user drags a file to a specific web page displayed by a browser according to an embodiment of the present invention.

FIG. 4 is a flowchart illustrating a method of using an electronic device to download a file from a server.

### DETAILED DESCRIPTION

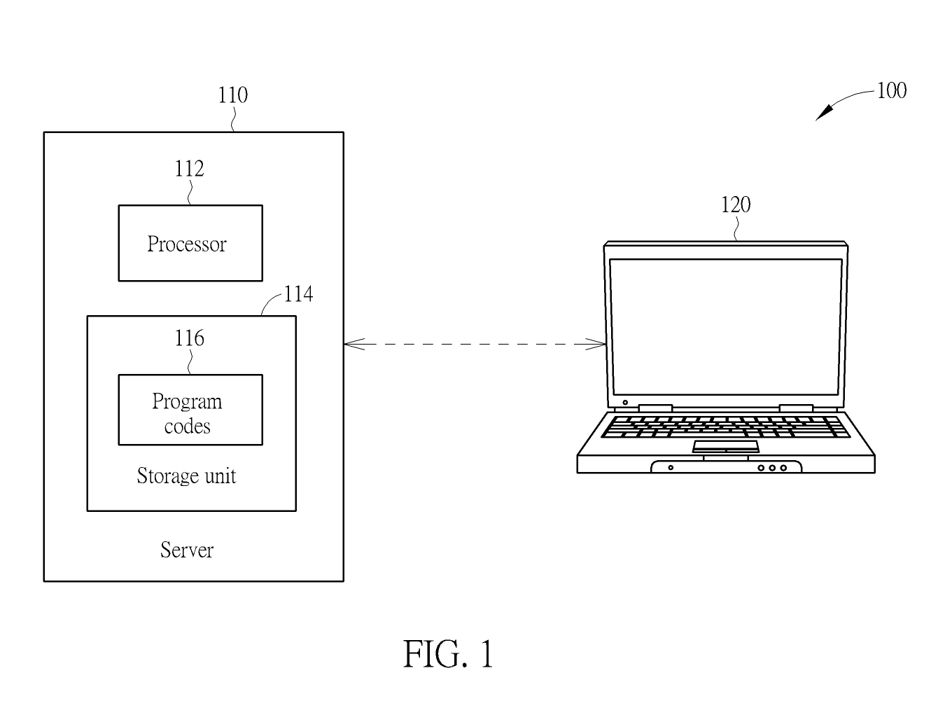

Refer to FIG. 1, which is a diagram illustrating a system 100 according to an embodiment of the present invention. As shown in FIG. 1, the system 100 includes a server 110 and an electronic device 120, in which the electronic device 120 is connected to the server 100 via a network such as the Internet, and the server 110 at least includes a processor 112 and a storage unit 114. The storage unit 114 stores a plurality of sets of program codes 116, and the processor 112 is arranged to execute a portion of the plurality of sets of program codes 116 to control operations of the server 112. Note that, although FIG. 1 only shows some elements in the server 110, one skilled in the art will readily know that there are other peripheral elements which may operate with the processor 112, and the storage unit 114 may substantially include a plurality of identical/different storage chips.

In this embodiment, the server 110 may be a file server, which is used as a cloud storage space so that the electronic device 120 can upload/download files through a browser via the Internet, but the present invention is not limited thereto. The server 110 may also be a multi-functional server (e.g. an all-in-one server), which can be used as a file server, web page server, remote authentication dial-in user service (RADIUS) server, remote access virtual private network server, proxy server, etc. In addition, the electronic device 120 may be any electronic device capable of using a browser, e.g. a desktop computer, laptop computer, smart phone, or tablet.

The plurality of sets of program code 116 includes a specific program code. For example, the specific program code in this embodiment may be a JavaScript code, which is arranged to be read by the electronic device 120 via a network and executed to partition a file into a plurality of portions in the electronic device 120, sequentially upload the plurality of portions to the server 110, real-time record upload progress of the file, and when uploading of the file is interrupted and the file is required to be re-uploaded, upload the remaining portions of the file that are not yet uploaded to the server 110 according to the recorded upload progress. That is, the uploaded portions of the file are not uploaded again, and the un-uploaded portions of the file are directly uploaded to the server 110. Operations associated with the specific program code and the system 100 are discussed in greater detail below.

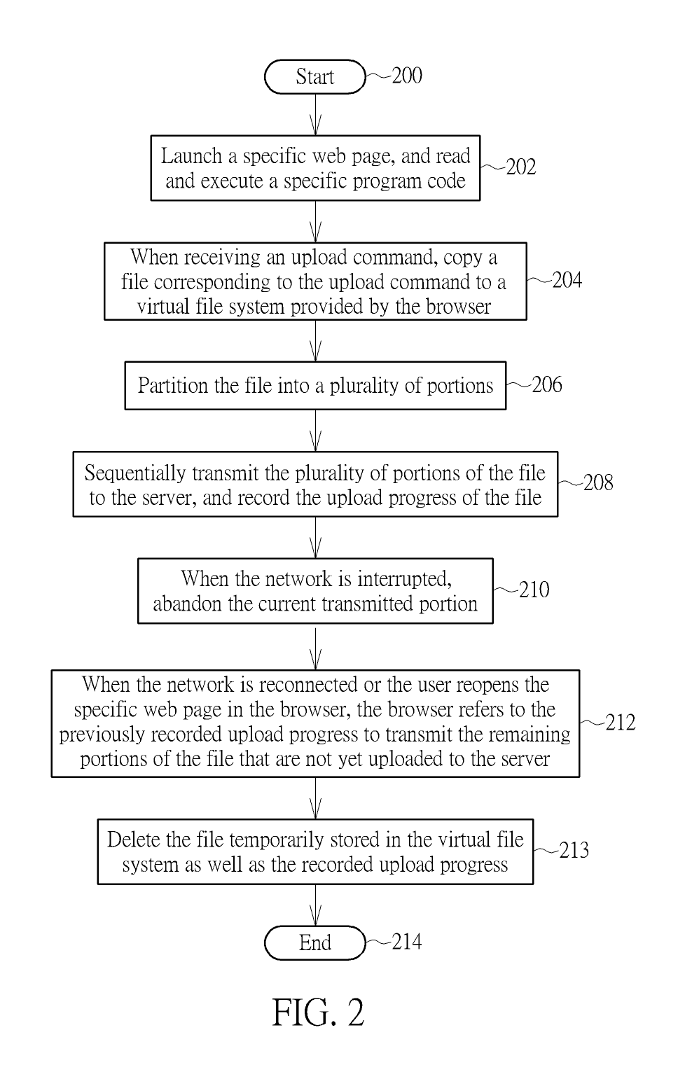

FIG. 2 is a flowchart illustrating a method of the electronic device 120 uploading a file to the server 110. In Step 200, the flow starts, and the electronic device 120 is connected to the server 110 via the network. In Step 202, the browser of the electronic device 120 launches a specific web page. At this time, the electronic device 120 will read the specific program code in the plurality of sets of program code 116 from the server 110, and execute it using a browser. In an embodiment, the specific web page may require the user of the electronic device 120 to enter a password for accessing the user account, so that the user can be identified and recorded.

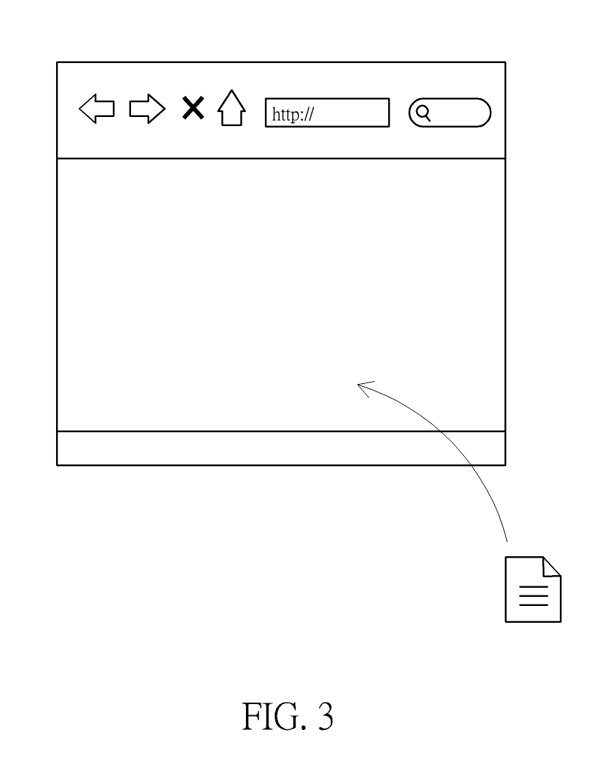

In Step 204, when the electronic device 120 receives an upload command, such as a command triggered by dragging a file to the specific web page in the browser as shown in FIG. 3, the file will be copied to the virtual file system provided by the browser. In an embodiment, when the electronic device 120 receives the upload command, the server 110 may allocate file uploading space according to a user identification (ID). More specifically, a predetermined size of file uploading space may be set up for a user ID, and if a user logins on the web page by such user ID, the server 110 may provide the predetermined size of file uploading space for the user.

In Step 206, the browser of the electronic device 120 partitions the file into a plurality of portions (e.g. a plurality of blocks), and is ready to sequentially transmit the plurality of partitions to the server 110. Since the transmission of the portions of the file can be performed according to the file application programming interface (File API) defined in the HTML5 specification, some detailed operations are omitted here for brevity.

In Step 208, the browser sequentially transmits the plurality of portions of the file to the server 110 via the network. At this point, both the browser of the electronic device 120 and the server 110 will record the upload progress of the file. The browser of the electronic device 120 will record which portion of the file is the last portion to have been successfully transmitted, and store the recorded progress into the virtual file system. The processor 112 of the server 110 will record which portion of the file is the last portion to have been successfully received, and store the recorded progress into the storage unit 114 or other storage devices. In an embodiment, the browser may display the upload progress of the file. In another embodiment, the browser may display a progress bar to indicate the progress of file transmission. In yet another embodiment, the progress bar may be divided into multiple blocks. For example, if the file is partitioned into 10 portions, then the progress bar can be divided into 10 blocks as well. Each block of the progress bar is used to indicate one of the portions of the file is successfully and completely transmitted to the server 110.

In Step 210, when the network is interrupted or shutdown, causing uploading of the file to be interrupted, the browser of the electronic device 120 and the server 110 will abandon the current transmitted portion (block), and the upload progresses of the browser of the electronic device 120 and the server 110 will not record this abandoned block. Assuming that the network connection of the electronic device 120 is interrupted when uploading the seventh block, for example, upload progress recorded by the browser of the electronic device 120 and the server 110 will record the sixth block as having been successfully uploaded/received. When uploading of the file is interrupted, the server 110 may temporarily store/reserve the received portions of the file in the storage unit 114 or other storage devices, rather than deleting them.

In Step 212, when the network is reconnected or the user reopens the specific web page in the browser, the browser of the electronic device 120 will refer to the previously recorded upload progress to transmit the remaining portions of the file that are not yet uploaded. Specifically, when the browser reconnects to the specific web page, the browser will execute a web page program code to demand the server 110 to check the user ID, and compare the aforementioned recorded upload progress of the file with an upload progress of the file recorded by the server 110, which can confirm whether the user ID is valid and determine an actual upload progress of the file. For example, if the browser records that the sixth portion of the file is the last portion to have been uploaded, but the server 110 records that the fifth portion of the file is the last portion to have been uploaded, the actual upload progress of the file will be the fifth portion. Note that only when the server 110 confirms that the user ID is valid will the server 110 allow the electronic device 120 to re-upload the file. Hence, when the server 110 confirms that user ID is still valid, the browser continues the uploading progress from the breakpoint of the file (e.g. the uploading begins from the sixth portion), rather than re-uploading the whole file.

In Step 213, when all portions of the file are uploaded to the server 110, the electronic device 120 deletes the file temporarily stored in the virtual file system provided by the browser, as well as the recorded upload progress. In Step 214, uploading of the file is completed, and the flow ends.

The file upload method provided by the present invention stores the file into the virtual file system of the browser so that the file can be partitioned and uploaded and its upload progress can be recorded at the same time. Hence, when the network connection is abnormal or the browser is shut down, resulting in the uploading of the file being interrupted, the browser may refer to the recorded upload progress to resume uploading, thus saving additional manual operations and improving the user experience.

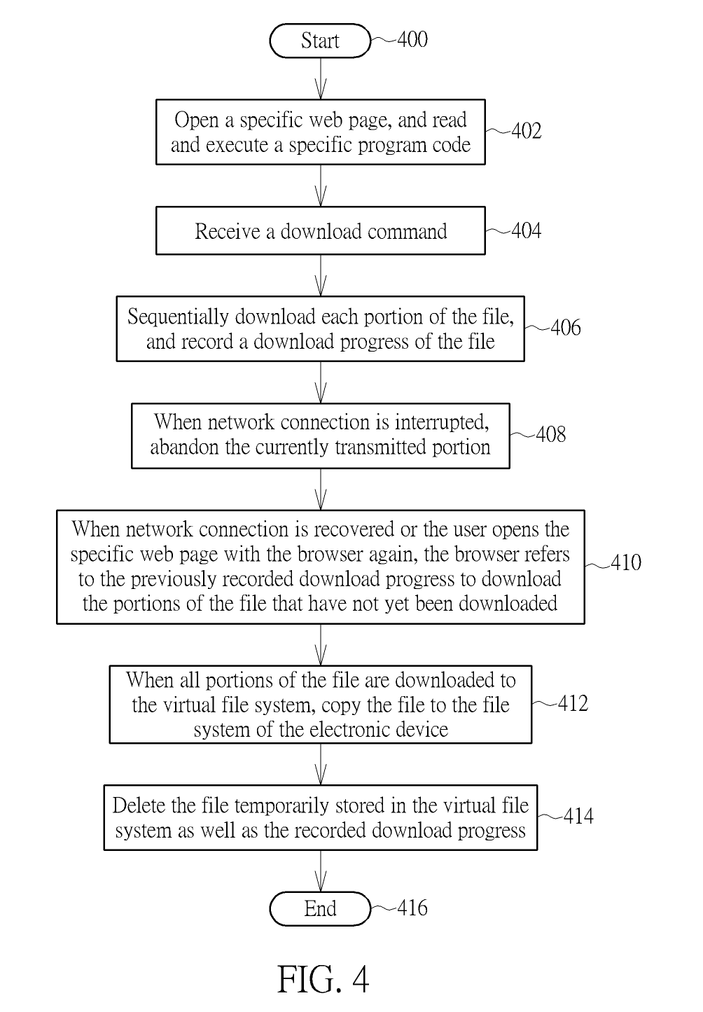

In addition to the method of uploading a file via a browser, another embodiment of the present invention discloses a method of downloading files from the server 110. FIG. 4 is a flowchart illustrating a method of using the electronic device 120 to download a file from the server 110. In step 400, the flow starts, and the electronic device 120 connects to the server 110 via a network. In step 402, the browser of the electronic device 120 opens a specific web page. At this moment, the electronic device 120 reads the specific program code in the plurality of sets of program code 116 from the server 110, and executes the specific program code via the browser. In an embodiment, the specific web page may further ask the user of the electronic device 120 to input a user ID and password, so that identification can be verified and recorded.

In step 404, the electronic device 120 receives a download command, e.g. the user requests the browser to download a file in the server 110. In step 406, the server 110 partitions the file into a plurality of portions (e.g. a plurality of blocks), and the browser of the electronic device 120 begins to sequentially download each portion of the file from the server 110 via the network. At this moment, the downloaded portions (e.g. blocks) are temporarily stored into a virtual file system provided by the browser, and both the browser of the electronic device 120 and the server 110 record a download progress of the file. The browser of the electronic device 120 will record which portion is the last portion to have been successfully received, and accordingly store the recorded progress into the virtual file system. Further, the processor 112 of the server 110 will record which portion is the last portion to have been successfully transmitted, and accordingly store the recorded progress into the storage unit 114 or other storage devices. In an embodiment, the browser may display the download progress of the file. In another embodiment, the browser may display a progress bar to indicate the progress of file transmission. In yet another embodiment, the progress bar may be divided into multiple blocks. For example, if the file is partitioned into 10 portions, then the progress bar can be divided into 10 blocks as well. Each block of the progress bar is used to indicate one of the portions of the file is successfully and completely downloaded from the server 110.

In step 408, when network connection is interrupted or the browser is shut down, thereby interrupting downloading of the file, both the browser of the electronic device 120 and the server 110 will abandon the currently transmitted portion (e.g. block), and neither the browser of the electronic device 120 nor the server 110 will record this abandoned block. Assuming that the network connection is interrupted when the electronic device 120 is downloading the seventh block, both the download progress recorded by the browser of the electronic device 120 and the download progress recorded by the server 110 will record that the sixth block is the last portion to have been successfully downloaded/transmitted. When downloading of the file is interrupted, the electronic device 120 will still temporarily store/reserve the received portions of the file into the virtual file system provided by the browser, rather than deleting the received portions of the file.

In step 410, when network connection is recovered or the user opens the specific web page with the browser again, the browser of the electronic device 120 will refer to the previously recorded download progress to download the portions of the file that have not yet been downloaded to the virtual file system. Specifically, when the browser is reconnected to the specific web page, the browser will utilize the web page program code to demand the server 110 to check the user ID and compare said recorded download progress with the download progress recorded by the server 110. The server 110 is asked to confirm whether the user ID is valid, and confirm the actual download progress of the file. For example, if the browser records that the third portion of the file is the last portion to have been downloaded, but the server 110 records that the fourth portion of the file is the last portion to have been transmitted, the actual download progress is the third portion. Note that only when the server 110 confirms that the user ID is still valid will the server 110 allow the electronic device 120 to re-download the file. Hence, when the server 110 confirms that the user ID is valid, the browser will continue downloading the portion from the breaking point of the file (i.e. from the fourth portion), rather than re-downloading the whole file. In this way, the portions which have already been received will not be re-downloaded.

In step 412, when all portions of the file are downloaded to the virtual file system, the electronic device 120 will copy the file to the file system of the electronic device 120. In step 414, the electronic device 120 deletes the file temporarily stored in the virtual file system provided by the browser, as well as the recorded download progress. In Step 416, the downloading of the file is completed, and the flow ends.

The file upload and download method and associated server of the present invention can directly resume file uploading/downloading from a point at which it breaks down. The problem of unnecessary re-uploading/downloading of the entire file as encountered in the related art can thereby be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A server, comprising:
a processor, arranged to control operations of the server; and
a storage unit, arranged to store at least one program code, wherein the program code is arranged to be read by an electronic device via a network and is executed by a browser of the electronic device, and when the program code is executed by the browser, the browser performs the following steps:
receiving an upload command, and copying a file corresponding the upload command to a virtual file system provided by the browser;
partitioning a file in the virtual file system into a plurality of portions;
sequentially uploading the portions to the server via the network, and real-time recording an upload progress of the file to generate a recorded upload progress; and
when uploading of the file is interrupted and the file is re-uploaded, transmitting remaining portions of the file that have not yet been transmitted to the server according to the recorded upload progress.

2. The server of claim 1, wherein when the electronic device sequentially uploads the plurality of portions to the server via the network, the processor real-time records the upload progress of the file.

3. The server of claim 2, wherein when uploading of the file is interrupted and the file is re-uploaded, the processor compares the recorded upload progress with an upload progress of the file recorded by the electronic device, to confirm an actual upload progress of the file.

4. The server of claim 2, wherein when uploading of the file is interrupted, the server temporarily stores the received portions of the file into the storage unit or a storage device; and when the file is re-uploaded by the electronic device, the server receives portions of the file that have not yet been received, rather than receiving already received portions of the file.

5. The server of claim 4, wherein after uploading of the file is interrupted, the server conforms whether a user identification (ID) of the electronic device is valid before allowing the electronic device to re-upload the file.

6. A file upload method applicable to a browser, the file upload method comprising:
receiving an upload command, and copying a file corresponding to the upload command to a virtual file system provided by the browser;
partitioning the file in the virtual file system into a plurality of portions;
sequentially uploading the portions to the server via a network, and real-time recording an upload progress of the file to generate a recorded upload progress; and
when uploading of the file is interrupted and the file is re-uploaded, transmitting remaining portions of the file that have not yet been transmitted to the server according to the recorded upload progress.

7. The file upload method of claim 6, further comprising:
when uploading of the file is interrupted and the file is re-uploaded, comparing the recorded upload progress with an upload progress of the file recorded by the server, to confirm an actual upload progress of the file; and
the step of transmitting the remaining portions of the file that have not yet been transmitted to the server according to the recorded upload progress comprises:
transmitting the remaining portions of the file that have not yet been transmitted to the server according to the actual upload progress of the file.

8. The file upload method of claim 6, further comprising:
after uploading of the file is interrupted, demanding the server to check a user identification (ID); and
after the server confirms that the user ID is valid, re-uploading the file.

9. The file upload method of claim 6, further comprising:
after all of the plurality of portions of the file are uploaded to the server, deleting the file in the virtual file system and the recorded upload progress.

10. The file upload method of claim 6, wherein the step of sequentially uploading the portions to the server via the network and real-time recording the upload progress of the file further comprises:
displaying the upload progress of the file on the browser.

11. A server, comprising:
a processor, arranged to control operations of the server; and
a storage unit, arranged to store at least one program code, wherein the program code is arranged to be read by an electronic device via a network, and is executed by a browser of the electronic device, wherein when the browser executes the program code, the browser executes the following steps:
receiving a download command, and sequentially downloading a plurality of portions of a file corresponding to the download command from the server to a virtual file system provided by the browser via the network, and real-time recording a download progress of the file to calculate a recorded download progress; and
after downloading of the file is interrupted and the file is re-downloaded, downloading remaining portions of the file that have not yet been downloaded to the virtual file system according to the recorded download progress.

12. The server of claim 11, wherein when the electronic device via the network sequentially downloads a plurality of portions of the file from the server to the virtual file system provided by the browser, the processor real-time records a download progress of the file.

13. The server of claim 12, wherein when downloading of the file is interrupted and the file is re-downloaded by the electronic device, the processor compares the recorded download progress with a download progress of the file recorded by the electronic device, to confirm an actual download progress of the file.

14. The server of claim 12, wherein when downloading of the file is interrupted, the electronic device temporarily stores received portions of the file into the virtual file system; and when the file is re-downloaded by the server, the electronic device receives portions of the file that have not yet been received, rather than receiving already received portions of the file.

15. The server of claim 14, wherein after downloading of the file is interrupted, the server confirms whether a user identification (ID) of the electronic is invalid before allowing the electronic device to re-download the file.

16. A file download method, applicable to a browser, the file download method comprising:
receiving a download command, and sequentially downloading a plurality of portions of a file corresponding to the download command to a virtual file system provided by the browser via a network, and real-time recording a download progress of the file;
when downloading of the file is interrupted and the file is re-downloaded, downloading remaining portions of the file that have not yet been downloaded to the virtual file system according to a recorded download progress; and
when all portions of the file are downloaded to the virtual file system, copying the file to a file system of the electronic device.

17. The file download method of claim 16, further comprising:
when downloading of the file is interrupted and the file is re-uploaded, comparing the recorded download progress with a download progress of the file recorded by the server, to confirm an actual download progress of the file; and
the step of downloading the remaining portions of the file that have not yet been downloaded to the virtual file system according to the recorded download progress comprises:
downloading remaining portions of the file to the virtual file system according to the actual download progress of the file which is confirmed.

18. The file download method of claim 16, further comprising:
after downloading of the file is interrupted, demanding the server to check a user identification (ID); and
after the server confirms that the user ID is valid, re-downloading the file.

19. The file download method of claim 16, wherein after all portions of the file are downloaded to the virtual file system, the step of copying the file to the file system of the electronic device further comprises:
deleting the file in the virtual file system and the recorded download progress.

20. The file download method of claim 16, wherein the step of sequentially downloading the plurality of portions of a file corresponding to the download command to the virtual file system provided by the browser via the network, and real-time recording the download progress of the file comprises:
displaying the download progress of the file on the browser.
